(19) United States
(12) Patent Application Publication
(10) Pub. No.: US 2025/0308205 A1
(43) Pub. Date: Oct. 2, 2025

(54) SYSTEMS AND METHODS FOR NEGATIVE SPACING LABELING AND SHADOW LABELING FOR COMPUTER VISION

(71) Applicant: Benevan Susanna Antony Raj, Mountain View, CA (US)

(72) Inventor: Benevan Susanna Antony Raj, Mountain View, CA (US)

(21) Appl. No.: 18/623,518

(22) Filed: Apr. 1, 2024

(51) Int. Cl. G06V 10/764; G06V 10/20; G06V 10/60; G06V 20/40; G06V 20/58

(52) U.S. Cl. CPC G06V 10/764; G06V 10/255; G06V 10/60; G06V 20/49; G06V 20/58

(57) ABSTRACT

The systems and methods described improve computer vision techniques. For example, they can gather, tag, and define natural light variations including shadows to create an understanding of objects' movements, shape variations speed of change to predict objects' movement. The systems and method described therein can also identify and label negative space in image data, which can be used to more easily identify areas of interest, for example, by removing the negative space.

### FIELD

This application relates to improved techniques for computer vision, and in particular, relates to negative space labeling and shadow labeling which improve artificial intelligence systems.

### BACKGROUND

Artificial intelligence (AI) has gained more and more interest in recent years and the market for AI is continuing to grow. AI has a wide variety of applications such as autonomous driving, virtual or augmented reality, medicine, energy and utilities, manufacture, among others, to improve these fields. Computer vision is a field of AI that enables computers and systems to derive meaningful information from digital images, videos and other visual inputs. Such information can then be used to take actions or make recommendations.

Computer vision is different from human vision, and it present a unique set of challenges. For example, human vision is equipped with the ability to process the context to identify objects, the distances among them, the spatial relationship, whether the objects are moving, and whether an image appears to be wrong. Computers do not have such capabilities. Instead, it must be trained using various machine learning and computer vision techniques in order to identify objects in an image. However, such training may be prong to errors and sometimes cannot achieve the level of accuracy required for real world applications.

### SUMMARY

The systems, methods, and devices of this disclosure each have several innovative aspects, no single one of which is solely responsible for various desirable attributes disclosed herein.

As one example, the systems and methods described therein can receive image data associated with an environment; process the image data to determine one or more images associated with the environment; identify negative space in the one or more images; label the negative space; and recognize subjects in the one or more images by determining the negative space around or in-between the subjects.

As another example, the systems and methods described therein can receive image data associated with an environment; determine light variations data associated with the environment; analyzes light variations data to identify one or more shadows in the environment; process the image data to identify one or more objects corresponding to the one or more shadows in the environment; and analyze the one or more shadows to predict movements of the one or more objects.

Details of one or more examples described therein are illustrated in the accompanying drawings and descriptions. Other features, aspects, use cases, and advantages may also become apparent from the disclosure of the entire specification. Neither this summary nor the detailed description below should be interpreted to define or limit the scope of the inventive subject matter.

### BRIEF DESCRIPTION OF THE DRAWINGS

Throughout the drawings, reference numbers are re-used to indicate correspondence between referenced elements. The drawings are provided to illustrate examples of the subject matter described herein and not to limit the scope thereof.

FIG. 1 illustrates an example of an image with positive space and negative space.

FIG. 2 is a block diagram of an example AI system for negative space labeling.

FIG. 3 is a process flow diagram illustrating an example of negative space labeling.

FIG. 4 is a block diagram of an example AI system for shadow labeling.

FIG. 5 is a process flow diagram illustrating an example of shadow labeling.

FIG. 6 illustrates an example computing device in connection with the present disclosure.

### DETAILED DESCRIPTION

### Overview

Computer vision training, particularly for object recognitions, faces accuracy issues and it requires tremendous hours of human labor to attain accurate labels. Traditional object recognitions employ positive image identification as a labeling method. It uses drawing tools such as boundary boxes to delineate the edges of an object or a person apart from their surroundings. As a result, only the positive space (e.g., the space that a subject) is labeled and the negative space around and in-between an object is not given much importance. Negative space, however, actually holds more information about the edges of the subject than the subject's boundaries. Instead of identifying the subject (positive space), identifying the negative space around subjects will speed up the training process and improve the accuracy. Negative space labeling can also be more effective than positive space labeling, especially in low contrast or complex imagery like congested traffic since drawing boundary boxes around the subject becomes difficult in these complex situations.

Furthermore, current training methods of edge detection use light variations to identify curves and edges use. These are problematic because they focus on contrast variation in high resolution images, thus ignoring natural formations of light variations including, for example, shadows which are predictable to a greater extent when direction of light is fixed and known. Moreover, the current methods use expensive equipment to measure variations in light changes and this information cannot be aggregated to create understanding for future uses in different environments. The disclosures herein address these issues by gathering, tagging and defining all such variations including shadows to create a general as well as a specific understanding of their movement, shape variations, speed of change to predict and enhance existing computer vision techniques. These improved techniques can predict the shadow or light occluding an entity's movements and non-movements as well as help define the size, shape and configuration of the entity to enhance computer vision to a whole new level.

By training AI systems (e.g., via LLM or Gen AI), the AI systems can under the environment to identify shadows and negatives, and it can add or remove shadows in some circumstances. For example, the AI system can be trained to learn from shadows and negative space, the techniques described herein enhance accuracy and inference predictions, and enable the system to detect and predict, for example, movements and objects with less computational resources. The AI system can be trained with all natural light and night light training of shadows in computer vision data labeling, as well as labeling negative space in images and visual data. The techniques described herein allow for universal application of knowledge learned through images, and is transferable to multiple devices, systems and industries. For example, the trained information can be applied in autonomous driving to detect obstacles and moving objects. It can also be used in the medical field to detect tumors and growths of tumors. It can further be used in other context to allow the AI system to understand objects in an environment and comprehend variations of light, to actively use such information to guide a user or AI system to move safely in the environment.

### Descriptions

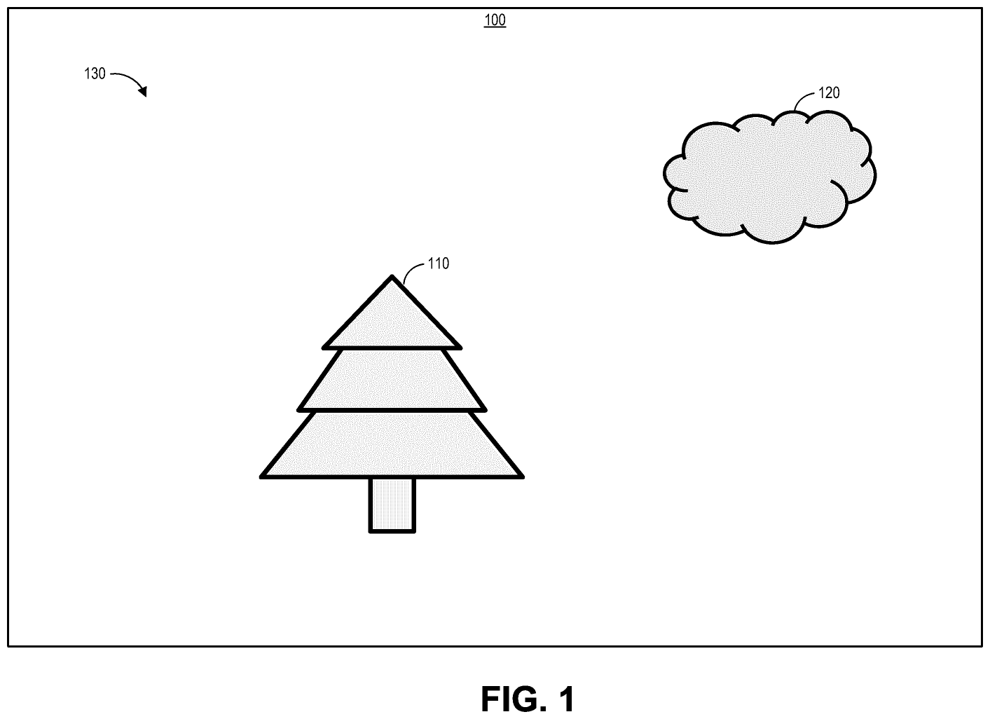

FIG. 1 shows an illustration of a positive space and a negative space in an image. The positive space can be the areas that are the subjects, or areas of interest. The negative space can be the area around the subjects or areas of interest. In the example image 100, the positive space is illustrated by objects 110 and 120, whereas the negative space is illustrated by the remainder of the space 130.

The techniques described herein can recognize, identify, and detect objects 110 and 120 by labeling negative space 130. The AI system described herein can identify the empty and label the negative space 130. In this example, the empty spaces will include the space associated with objects 110 and 120. The AI system can accordingly determine the positive space after the negative space is labeled.

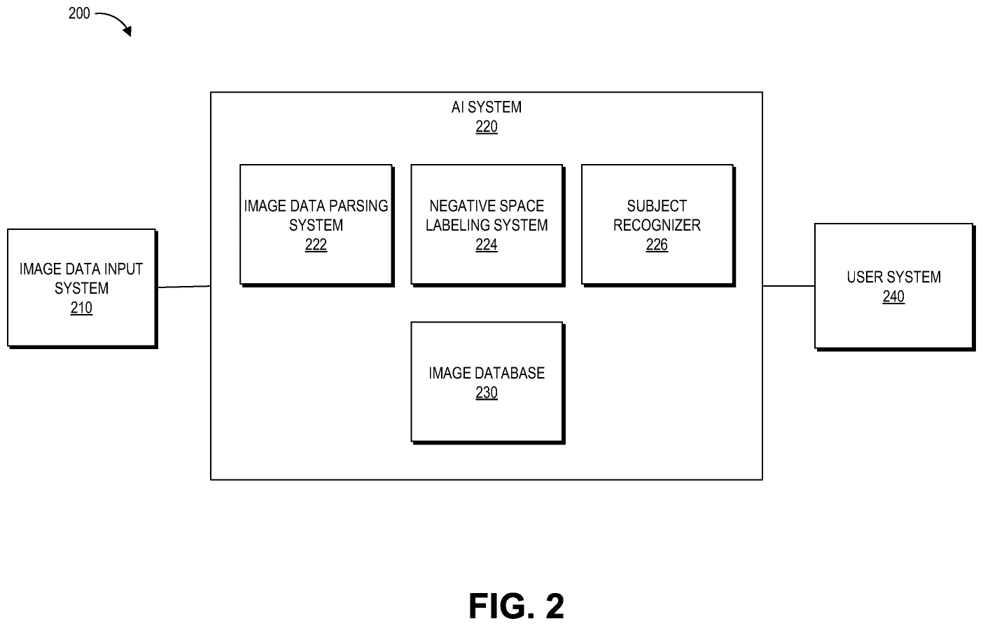

FIG. 2 is a block diagram of an example AI system for negative space labeling. The system 200 includes, for example, an image data input system 210, an AI system 220, and a user system 240. The location of blocks in the figures is for illustration purposes only and is not limiting. In some situations, the image data input system 210 and/or the user system 240 may be part of the AI system 220. Also, one or more components of the AI system 220 may be implemented in a distributed architecture, rather than on a single computing system or device.

The image data input system 210 can include one or more sensors, cameras, scanners, lidars, and other systems that can acquire image data. The image data can include data include one or more of still images, photographs, animations, individual frames from a video, or a video. The visual data can be associated with an environment, such as roads. The image data input system 210 can also acquire audio and other types of data in addition to visual data. The image data input system 210 can store the image data in a data repository local or remote to the image data input system 210. The image data can also be stored in the image database 230.

The image data can be sent or streamed to the AI system 220, which performs processing on the image data, for example, by performing training on the image data. The image data can also be sent to a user system 240 or the AI system 220 where a model is applied to recognize an object in an environment or to determine the movements of an object.

The AI system 220 can include components such as image data parsing system 222, negative space labeling system 224, subject recognizer 226, and image database 230. One or more of these systems can be optional or be part of another system. For example, the image data parsing system 222 may be part of the negative space labeling system 224.

The image data parsing system 222 can receive or otherwise obtain image data from the image data input system 210. The image data parsing system 222 may obtain such image data from the image database 230. The image data parsing system 222 can perform data cleaning and processing so that the other components of the AI system 220 such as negative space labeling system 224 and subject recognizer 226 can better or further process the image data. For example, the image data parsing system 222 may perform scene construction. The image data parsing system 222 can also arrange the image data, generate images, or clean the image data. The data processed by the image data parsing system can also be stored in the image database 230.

The negative space labeling system 224 can process the image data to identify negative space in one or more images. These images can be associated with 2D or 3D imaging. As one example, the negative space labeling system 224 can use computer vision or machine learning algorithms to identify blank spaces in an image. It can also identify the blank space based on certain criteria: such as the shape of the blank space, the area of the blank space, the location of the blank space. These criteria can be combined with the environment at issue. For example, a congested city road environment may require a different set of criteria than a less congested country road environment. The criteria may also be different between an indoor environment and an outdoor environment. The negative space labeling system 224 can train or apply a machine learning model to identify the negative space in the one or more images. The negative space labeling system 224 can also use the image data to perfect or update an existing machine learning model for identifying negative space. The negative space labeling system 224 can communicate with the image database 230 to perform its function. The negative space labeling system 224 can also store the machine learning model in the image database 230.

Once the negative space is labeled, the AI system may determine the remaining space in an image is the area of interest and perform further processing on the remaining area. The AI system 220 can include one or more subject recognizers 226. Based on the information from the negative space labeling system, or data in the map database 230, the subject recognizer(s) may recognize subjects and objects in an environment. For example, the subject recognizers 226 can recognize faces, persons, roads, signs, buildings, structures, and other items in an environment. A subject recognizer may be specialized for recognizing items with certain characteristics. For example, a subject recognizer may be used to recognize persons, while another subject recognizer is used to recognize road signs.

The image database 230 can store image data from the image data input system 201 as well as data for the other systems within the AI system 220. For example, the image database 230 may include various points collected over time, their corresponding objects or environments. The image database can connect to various devices through a network (e.g., LAN, WAN, etc.). The image database can also include a cluster of databases, which may be in communication with components of the AI system, image data input system or user system. These databases can be local or remote to the AI system 220, image data input system 210 or the user system 240. Overtime, the image database can grow as a system (which may reside locally or may be accessible through a wireless network) and accumulate more data from the environment. Once the information about the environment is processed, the information may be transmitted to one or more user systems 240.

The user system 240 can apply the output of the AI system 220 for various interactions in an environment. For example, the user system 240 may be an autonomous driving system that can cause a car to move in accordance with the road environment. The user system 240 may also be associated with a medical application that may use the model from the AI system 220 to predict tumor growth or to identify an anomaly. In some situations, the user system 240 may include the image data input system 210 so that the information acquired by the image data input system 210 will be processed and fed back for application by the user system 240.

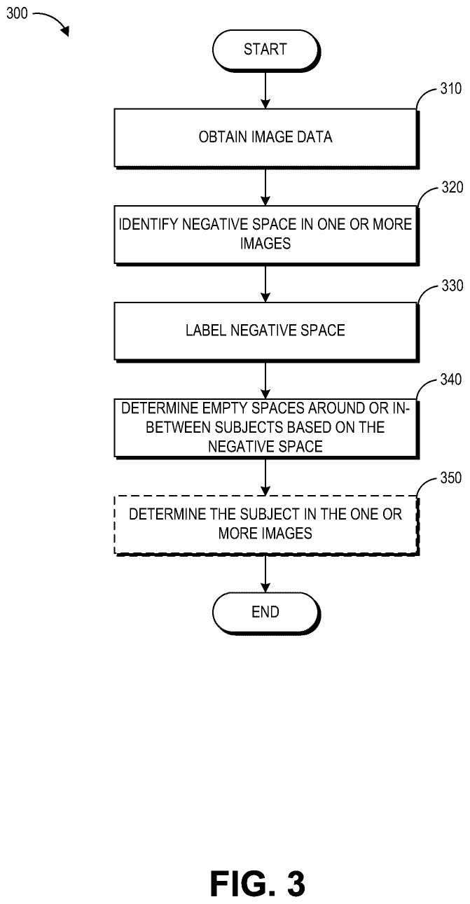

FIG. 3 describes an example process of negative space labeling. The example process 300 can be performed by the AI system 220 alone or in combination with an input system or a user system.

At block 310, the system obtains image data. The image data can be video data or photographic data. For example, it can be video sequences, views from one or more cameras, data from 2D or 3D scanners, etc. In some situations, the data may go through reconstructions or preprocessing to produce one or more images. The image data may be obtained from sources, such as digital sensors, cameras, scanners, etc., individually or in combination. The image data may also be obtained from data repositories local or remote to the AI system. As one example, the image data may be obtained from the image data input system 210. The image data may include images at substantially the same depth or different depths. The image data can be acquired at substantially the same time or during multiple sessions. It may also be streamed.

At block 320, the system can process the image data to identify negative space in one or more images. These images can be associated with 2D or 3D imaging. In some implementations, the system may use Harris corner detectors and/or information around the edges and corners to detect the boundary, edges, corners, or the end of objects. For example, the system can recognize blank spaces in an image and identify such spaces as a negative space. The system may use the information around the edges and corners to detect the end of objects. A variety of algorithms may be used to recognize blank spaces and edges/corners. For example, the system may employ neural networks, convolutional neural networks, shape recognition, Harris corner detection, other machine learning algorithms to train the system to make such identification. The system can also set certain conditions associated with detecting blank spots in an image and determining the area of such blank spots, in order to determine whether it is a negative space. The negative space may include one or more blank areas which may be enclosed by positive space or adjacent to one another. The negative space may also include blank space between a positive space and the boundary of an image.

At block 330, the system can label the negative space. For example, the system can determine the boundary of the negative space and label the boundary. The system can also tag the negative space to indicate that the areas marked belong to the negative space.

At block 340, the system can determine subjects (which are usually associated with a positive space) based on the negative space. For example, the system may determine that the space left after the negative space is drawn is the positive space. The system may also crop out the negative space in an image such that only positive space is remaining. Optionally, at block 350, the system can determine the subject(s) in the one or more images. For example, based on the information in the remaining positive space (as determined through labeling the negative space), the system can use algorithms, such as neural network, convolutional neural network, and other object recognition or machine learning algorithms to determine the subjects within the positive space.

The output of the process 300 can be applied by a variety of systems, such as a user system or an AI system to predict objects in an environment. For example, the output may be used by an autonomous driving system to detect road/lanes, obstacles, persons, signs, etc., while driving. It can also be used in the medical field to determine the existence of a tumor or a tumor's growth.

The AI system described herein can also perform shadow labeling. Shadow labeling can be performed by the AI system in addition or in an alternative to negative space labeling. For example, the AI system may obtain image data which can be used to perform both shadow labeling and negative space labeling for one or more images or environments.

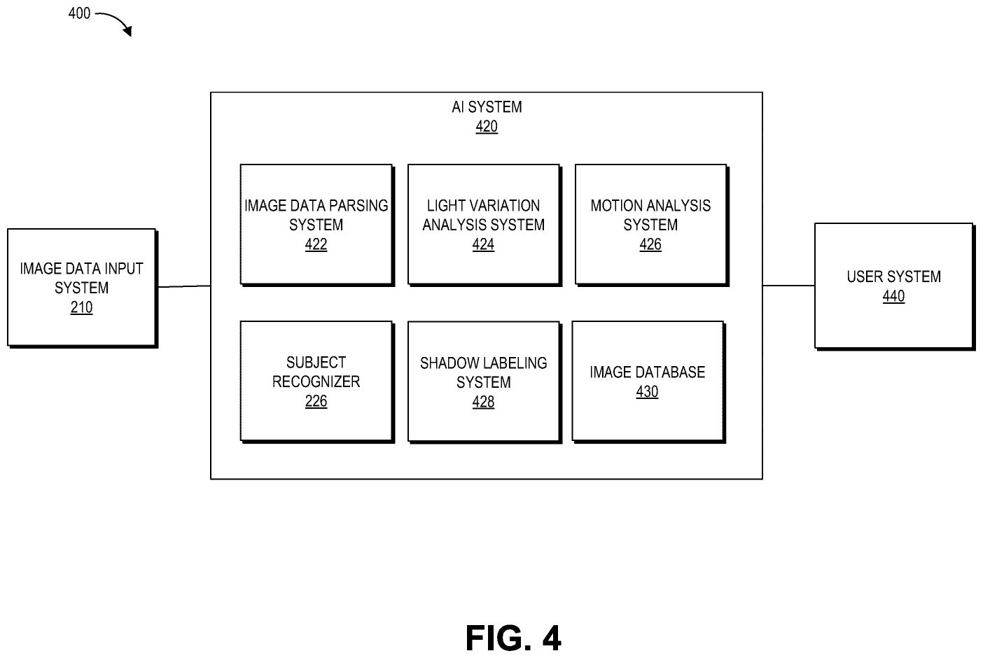

FIG. 4 illustrates an example system 400 for shadow labeling. The system 400 includes, for example, an image data input system 210, an AI system 420, and a user system 440. The location of blocks in the figures is for illustration purposes only and is not limiting. In some situations, the image data input system 410 and/or the user system 440 may be part of the AI system 420. Also, one or more components of the AI system 220 may be implemented in a distributed architecture, rather than on a single computing system or device. Furthermore, the AI system 420 may be combined with the AI system 220 to form a single system, where one or more components of the two systems may be shared. The image data input system 210 may perform similar functions as those illustrated in FIG. 2.

The AI system 420 can gather, tag and define natural light variations including shadows to create a general as well as a specific understanding of environment. For example, the AI system can identify and predict an object's movement, shape variations, speed of change, which can then enhance autonomous devices and vehicles. The AI system 420 can also predict the shadow or light occluding an object's movements and non-movements as well as help define the size, shape and configuration of the object.

The AI system 420 can use computer vision and object recognition algorithms to identify categories and subcategories of objects (e.g., roads, signs, persons, buildings, etc.). The AI system 420 may track variations in image pixels or variations in density of light in the acquired images. The AI system 420 can use these variations to predict whether a shadow is moving or stationary. For example, the AI system 420 can train and update a machine learning model to derive meaning from the image data and to classify and tag visual objects in the image data. By tracking variations in the image pixels or variations in density of light, the system can predict that a shadow is moving or stationary. Pixel variation and light density variations are used by the system to make this prediction. The AI system 420 can also be trained to predict and identify a mobile object that is providing the light variations. The AI system 420 can also use the information associated with the classified and tagged objects to predict the direction of light variations. For example, the AI system 420 can identify, define and predict the movement of an object which casts and forms a shadow (e.g., when it's moving). The AI system 420 can also track and predict the trajectory of the shadows for objects that are mobile, immobile, or temporarily stopped. For example, the AI system 420 can track and predict the movement path of a moving car or a car that's temporary stopped at the traffic light. The AI system 420 can also track the shadow of a stationary object, such as a building or a sign, where the shadow may appear different depending on the natural light.

The AI system 420 can include components such as image data parsing system 422, light variation analysis system 424, motion analysis system 426, subject recognizer 226, shadow labeling system 428, and image database 430. One or more of these systems can be optional or be part of another system. For example, the image data parsing system 422 may be part of the light variation analysis system 424, motion analysis system 426, and/or shadow labeling system 428. The light variation analysis system 424, motion analysis system 426, and/or shadow labeling system 428 may also be combined to form a single system. The light variation analysis system 424, motion analysis system 426, and/or shadow labeling system 428 may also work together to train or update a machine learning model to determine an object's movement or shadow. The output of one or more of these systems may be used by the AI system 420 to predict the movement of the object.

Image data parsing system 422 may be the same system or implemented together with the image data parsing system 222. It can receive or otherwise obtain image data from the image data input system 210 or from the image database 430. The image data parsing system 422 can perform data cleaning and processing so that the other components of the AI system 420, such as the light variation analysis system 424, motion analysis system 426, shadow labeling system 426 and subject recognizer 226 to aid the processing of the image data. For example, the image data parsing system 422 may perform scene construction. The image data parsing system 422 can also arrange the image data, generate images, or clean the image data. The data processed by the image data parsing system can also be stored in the image database 430.

The light variation analysis 424 can analyze the image data in view of natural light formations. For example, the light variation analysis system 424 can classify and sort the incoming sources for variations in light, and accordingly define categories of light sources. It can also define categories of energy strengths of light differences and uses machine learning models or training to classify and sort the variations in energy strengths of light differences in the image data.

The light variation analysis system 424 can also classify light shapes and variations by an object or entity's definitions and attributes. For example, the light variation system 424 can define and classify the variations in light in accordance with an object's form and structure and their ability to remain immobile or mobile. The light variation analysis system 424 can also define subcategories of light variations, such as subcategories associated with shadows to determine whether a shadow and its associated object is moving or non-moving. The shadows may be form shadows which are shadows on an object or cast shadows which can be shadows of an object that casts on another object or the empty area in an image (e.g., shadow of a tree casted on a house). Unlike traditional techniques which use feature detection and image registration, and detect variations based on pixel differences from overlays of images, the system here trains one or more AI models directly using, e.g., each image. The AI model can aggregate training of actual light variations in its core, and it can find differences of the variations in each image sequence. Although pixel differences may still be used by the light variation analysis system 424, the system here can determine the differences in each image based on a predictive model, after being trained with numerous images (e.g., with Generative AI). This predictive model can learn from hundreds or thousands of images from various angles regarding how the light moves to create a shadow. The light variation analysis system 424 may analyzes image data and define subcategories of stationary cast shadows versus non-stationary cast shadows. The light variation analysis system may also determine subcategories of objects associated with shadows, such as buildings, objects, trees, people, vehicles, etc. While some objects in the image data may be mobile (such as people or vehicles), the light variation analysis system 424 may analyze the variations in light by these objects' ability to change or move which may cause variations in light. The light variation analysis system 424 can further attach semantics and create detailed ontologies for each category and subcategory of objects and their associated light variations. Light variation analysis system 424 can define, label and classify numerous properties of the common or uncommonly used lexicon in various languages. For example, the light variation analysis system 424 can employ AI techniques (such as LLM) to gain a broader lexicon to its prediction outputs with the labeling of shadows in the environment. For example, a human may provide the labeling but the AI system with its understanding of natural human language (e.g., using LLM models), can use the labels as an input to gain a broader lexicon and build a detailed human language ontology to label shadows in various scenarios. In some situations, the light variation analysis system 424 may work with the subject recognizer 226, the motion analysis system 426, and/or the shadow labeling system 428 to achieve these functions.

The subject recognizer 226 was discussed earlier with reference to FIG. 2. It can facilitate the training of the AI system 420 to identify each category and subcategory of objects and their associated shadows.

The motion analysis system 426 can predict the trajectory of moving shadows (whether they are cast shadows or form shadows). For example, it can update or apply the machine learning models processed by the other components of the AI system 420, such as the light variation analysis system 424 to understand the direction of light variations in the objects that are mobile. The motion analysis system 426 can also predict the direction of shadows for immobile or stationary objects based on the direction of light variations.

Shadow labeling system 428 can work with the light variation analysis system 424 to sort, classify and tag shadows. For example, it can label each category and subcategory of shadows in the image data (which may comprise images and videos). It can use the lexicon provided in the ontologies for the visual objects to perform the labeling. The shadow labeling system 428 can also sort, classify, and tag variables not included in the lexicon provided in the ontologies. For example, it can also label the shadows that do not belong to the defined categories or subcategories.

Image database 430 can store data related to one or more of image data, machine learning models, light shapes, directional trajectories. The image database 430 may be accessed by various components in the AI system 420 to predict the movement of light variations in the environment (which may include the entire 360-degree space of the environment). The image database 430 may also store information similar to those stored in the image database 230. In some situations, the image database 430 and the image database 230 may be the same or have similar implementations.

User system 440 can apply the output of the AI system 220 for various interactions in an environment. For example, the user system 440 may be an autonomous driving system that can cause a vehicle to move in accordance with the road environment. Based on the predictions of moving objects and obstacles (e.g., in accordance with the natural light variations or shadows), the vehicle can be automatically maneuvered to avoid collisions. In some situations, the user system 440 may include the image data input system 210 so that the information acquired by the image data input system 210 will be processed and fed back for application by the user system 440.

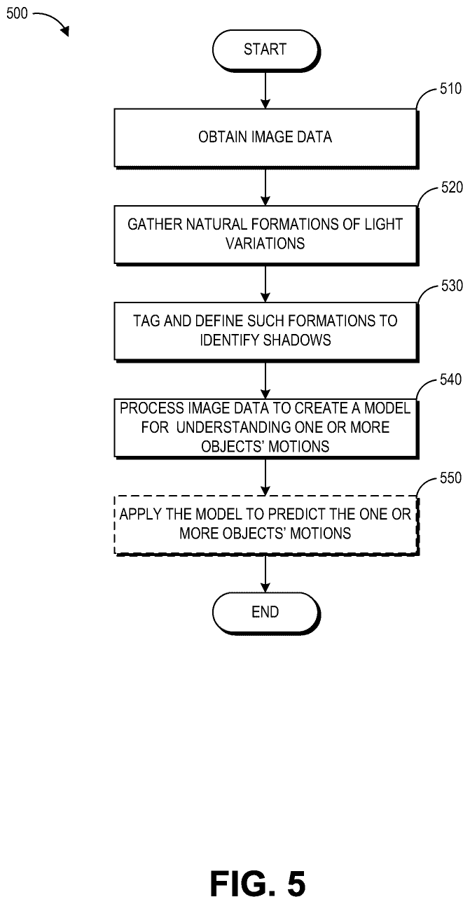

FIG. 5 describes an example process of shadow labeling. The example process 500 can be performed by the AI system 420 alone or in combination with an input system or a user system (such as those illustrated in FIG. 4).

At block 510, the system obtains image data. The image data can be video data or photographic data. For example, it can be video sequences, views from one or more cameras, data from 2D or 3D scanners, etc. In some situations, the data may go through reconstructions or preprocessing to produce one or more images. The image data may be obtained from sources, such as digital sensors, cameras, scanners, etc., individually or in combination. The image data may also be obtained from data repositories local or remote to the AI system. As one example, the image data may be obtained from the image data input system 210. The image data may include images at substantially the same depth or different depths. The image data can be acquired at substantially the same time or during multiple sessions. It may also be streamed.

At block 520, the system can identify natural formations of light variations. For example, the system can analyze and parse image data to gather information about the direction of light and identify objects to determine the shadows. The system can use depth estimation, light perspectives, and scene understanding to perform the identification. The system may use an AI model which understands the scenes and objects therein, coupled with the understanding of light variations to build one or more predictive models to detect the objects and shadows. The system can be an AI system that has comprehensive knowledge (e.g., acquired through training of the AI models) about objects in an environment, light and shadows, which can predict a moving object's direct. The information about light and its directions can be obtained from the image data or another source. For example, the light and its direction can be obtained from an optical sensor or other types of sensor that observes an environment. The system can classify and sort the incoming sources for variations in light, and accordingly define categories of light sources. It can also define categories of energy strengths of light differences and uses machine learning models or training to classify and sort the variations in energy strengths of light differences in the image data. In some situations, the system can gather light information and object information and train them separately and the knowledge from both training to understand the shadows, as well as the movements of the shadows and the objects.

At block 530, the system can analyze the image data to tag and identify shadows. For example, the system can classify light shapes and variations by an object or entity's definitions and attributes. The system can also define subcategories of light variations, such as subcategories associated with shadows to determine whether a shadow and its associated object is moving or non-moving.

At block 540, the system can analyze the image data and the shadows to understand the movement of a movable object. For example, the system may analyze the variations in light by these objects' ability to change or move which may cause variations in light.

At block 550, the system can optionally predict an object's motion. can predict the trajectory of moving shadows (whether they are cast shadows or form shadows). For example, it can update or apply the machine learning models processed by the AI system to understand the direction of light variations in the objects that are mobile. It can also predict the direction of shadows for immobile or stationary objects based on the direction of light variations.

### Overview of a Computing Device

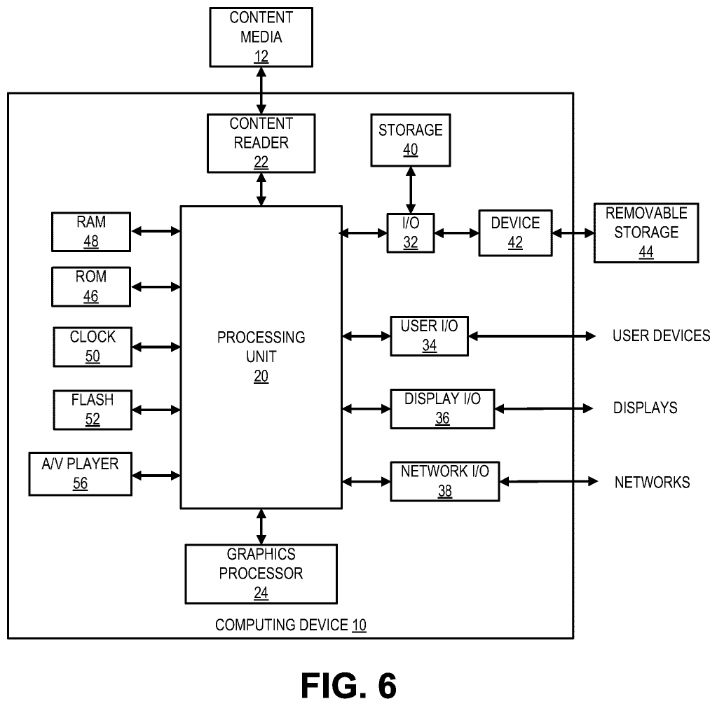

FIG. 6 illustrates an example of a computing device 10 according to the present disclosure, which can be used to implement any of the systems and/or run the processes disclosed herein. Other variations of the computing device 10 may be substituted for the examples presented herein, such as removing or adding components to the computing device 10. The computing device 10 may include a portable or wearable device, a smart phone, a tablet, a personal computer, a laptop, a smart television, a car console display, a computing unit in a vehicle, a server, and the like.

As shown, the computing device 10 includes a processing unit 20 that interacts with other components of the computing device 10 and also external components to computing device 10. A media reader 22 is included that communicates with media 12. The media reader 22 may be an optical disc reader capable of reading optical discs, such as CD-ROM or DVDs, or any other type of reader that can receive and read data from content media 12. One or more of the computing devices may be used to implement one or more of the systems disclosed herein.

Computing device 10 may include a separate graphics processor 24. In some cases, the graphics processor 24 may be built into the processing unit 20. In such cases, the graphics processor 24 may share Random Access Memory (RAM) with the processing unit 20. Alternatively, or in addition, the computing device 10 may include a discrete graphics processor 24 that is separate from the processing unit 20. In some such cases, the graphics processor 24 may have separate RAM from the processing unit 20. Computing device 10 might be a handheld device, a dedicated computing system, a general-purpose laptop or desktop computer, a smart phone, a tablet, a car console, or other suitable system.

Computing device 10 also includes various components for enabling input/output, such as an I/O 32, a user I/O 34, a display I/O 36, and a network I/O 38. I/O 32 interacts with storage element 40 and, through a device 42, removable storage media 44 in order to provide storage for computing device 10. Processing unit 20 can communicate through I/O 32 to store data, such as training or model data and any shared data files. In addition to storage 40 and removable storage media 44, computing device 10 is also shown including ROM (Read-Only Memory) 46 and RAM 48. RAM 48 may be used for data that is accessed frequently, such as when a machine learning model is being trained or applied.

The computing device 10 may implement one or more components or the entirety of the AI system described herein (such as the AI system 220, 420). The AI system may employ machine learning, computer vision, and/or object recognition algorithms to carry out its functions. Some examples of machine learning algorithms can include supervised or non-supervised machine learning algorithms, including regression algorithms (e.g., Ordinary Least Squares Regression), instance-based algorithms (e.g., Learning Vector Quantization), decision tree algorithms (e.g., classification and regression trees), Bayesian algorithms (e.g. Naive Bayes), clustering algorithms (e.g., k-means clustering), association rule learning algorithms (e.g., a-priori algorithms), artificial neural network algorithms (e.g., Perceptron), deep learning algorithms (e.g., Deep Boltzmann Machine, or deep neural network), dimensionality reduction algorithms (e.g., Principal Component Analysis), ensemble algorithms (e.g., Stacked Generalization), and/or other machine learning algorithms. The training can also be customized based on a base model. For example, the base model may be used as a starting point to generate additional models specific to a data type (e.g., pedestrians, cars, road signs), a data set (e.g., a set of additional images obtained from one or more sensors or cameras in a car), conditional situations, or other variations. The AI system described herein can be configured to utilize a plurality of techniques to generate models for the analysis of the aggregated data. Other techniques may include using pre-defined thresholds or data values.

The object recognition may be performed using a variety of computer vision techniques. For example, the AI system can analyze the images acquired by sensors, cameras or scanners, etc., to perform scene reconstruction, event detection, video tracking, object recognition (e.g., persons or road signs), object pose or motion estimation, facial recognition, learning, indexing, motion estimation, or image analysis (e.g., identifying points of interest or blank spaces in an image), and so forth. One or more computer vision algorithms may be used to perform these tasks. Non-limiting examples of computer vision algorithms include: Scale-invariant feature transform (SIFT), speeded up robust features (SURF), oriented FAST and rotated BRIEF (ORB), binary robust invariant scalable keypoints (BRISK), fast retina keypoint (FREAK), Viola-Jones algorithm, Eigenfaces approach, Lucas-Kanade algorithm, Horn-Schunk algorithm, Mean-shift algorithm, visual simultaneous location and mapping (vSLAM) techniques, a sequential Bayesian estimator (e.g., Kalman filter, extended Kalman filter, etc.), bundle adjustment, Adaptive thresholding (and other thresholding techniques), Iterative Closest Point (ICP), Semi Global Matching (SGM), Semi Global Block Matching (SGBM), Feature Point Histograms, various machine learning algorithms (e.g., support vector machine, k-nearest neighbors algorithm, Naive Bayes, neural network (including convolutional or deep neural networks), or other supervised/unsupervised models, etc.), and so forth.

User I/O 34 is used to send and receive commands between processing unit 20 and user devices. In some examples, the user I/O 34 can include a touchscreen input. The touchscreen can be a capacitive touchscreen, a resistive touchscreen, or another type of touchscreen technology that is configured to receive user input through tactile inputs from the user. Display I/O 36 provides input/output functions that are used to display images associated with the artificial intelligence system. Network I/O 38 is used for input/output functions for a network. Network I/O 38 may be used during execution of the artificial intelligence system, such as during autonomous driving.

Display output signals produced by display I/O 36 comprise signals for displaying visual content produced by computing device 10 on a display device, such as graphics, user interfaces, video, and/or other visual content. Computing device 10 may comprise one or more integrated displays configured to receive display output signals produced by display I/O 36. According to some examples, display output signals produced by display I/O 36 may also be output to one or more display devices external to computing device 10, such a display.

The computing device 10 can also include other features that may be used with an artificial system, such as a clock 50, flash memory 52, and other components. An audio/video player or user 56 might also be used to play a video sequence, such as a movie. It should be understood that other components may be provided in computing device 10 and that a person skilled in the art will appreciate other variations of computing device 10.

Program code can be stored in ROM 46, RAM 48 or storage 40 (which might comprise hard disk, other magnetic storage, optical storage, other non-volatile storage or a combination or variation of these). Part of the program code can be stored in ROM that is programmable (ROM, PROM, EPROM, EEPROM, and so forth), part of the program code can be stored in storage 40, and/or on removable media such as content media 12 (which can be a CD-ROM, cartridge, memory chip, or the like, or obtained over a network or other electronic channel as needed). In general, program code can be found embodied in a tangible non-transitory signal-bearing medium.

Random access memory (RAM) 48 (and possibly other storage) is usable to store variables and other machine learning model and processor data as needed. RAM 48 is used and holds data that is generated during the execution of an application and portions thereof might also be reserved for frame buffers, application state information, and/or other data needed or usable for interpreting user input and generating display outputs. Generally, RAM 48 is volatile storage and data stored within RAM 48 may be lost when the computing device 10 is turned off or loses power.

As computing device 10 reads media 12 and provides an application, information may be read from content media 12 and stored in a memory device, such as RAM 48. Additionally, data from storage 40, ROM 46, servers accessed via a network (not shown), or removable storage media 46 may be read and loaded into RAM 48. Although data is described as being found in RAM 48, it will be understood that data does not have to be stored in RAM 48 and may be stored in other memory accessible to processing unit 20 or distributed among several media, such as media 12 and storage 40.

### Additional Considerations

Each of the processes, methods, and examples described in the specification and drawings can be fully or partially automated by, code modules executed by one or more physical computing systems, hardware computer processors, application-specific circuitry, and/or electronic hardware configured to execute specific and particular computer instructions. For example, computing systems can include general purpose computers (e.g., servers) programmed with specific computer instructions or special purpose computers, special purpose circuitry, and so forth. A code module or program may be compiled and linked into an executable program, installed in a dynamic link library, or may be written in an interpreted programming language.

Certain implementations or aspects of the functionality described above can be sufficiently mathematically, computationally, or technically complex that application-specific hardware or one or more physical computing devices (utilizing appropriate specialized executable instructions) may be necessary to perform the functionality, for example, due to the volume or complexity of the calculations involved or to provide results substantially in real-time.

Code modules or any type of data may be stored on any type of non-transitory computer-readable medium, such as physical computer storage including hard drives, solid state memory, random access memory (RAM), read only memory (ROM), optical disc, volatile or non-volatile storage, combinations of the same or the like. They may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The various processes or process steps described therein may be stored, persistently or otherwise, in any type of non-transitory, tangible computer storage or may be communicated via a computer-readable transmission medium.

Any processes, blocks, states, steps, or functionalities in flow diagrams described herein should be understood as potentially illustrating code modules, segments, or portions of code which include one or more executable instructions for implementing specific functions (e.g., logical or arithmetical) or steps in the process. The various processes, blocks, states, steps, or functionalities can be combined, rearranged, added to, deleted from, modified, or otherwise changed from the illustrative examples provided herein. Additional or different computing systems or code modules may perform some or all of the functionalities described herein. The methods and processes described herein are also not limited to any particular sequence, and the blocks, steps, or states relating thereto can be performed in other sequences that are appropriate, for example, in serial, in parallel, or in some other manner. Tasks or events may be added to or removed from the disclosed examples. Moreover, the separation of various system components in the implementations described herein is for illustrative purposes and should not be understood as requiring such separation in all implementations. It should be understood that the described program components, methods, and systems can generally be integrated together in a single computer product or packaged into multiple computer products. Many implementation variations are possible.

The processes, methods, and systems described therein may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network or any other type of communication network.

The systems and methods of the disclosure each have several innovative aspects, no single one of which is solely responsible or required for the desirable attributes disclosed herein. The various features and processes described above may be used independently of one another, or may be combined in various ways. All possible combinations and sub-combinations are intended to fall within the scope of this disclosure. Various modifications to the implementations described in this disclosure may be readily understood by those skilled in the art, and the generic principles defined herein may be applied to other implementations without departing from the spirit or scope of this disclosure. Thus, the claims are not intended to be limited to the examples described therein but are to be accorded the widest scope consistent with this disclosure, the principles and the novel features disclosed therein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. No single feature or group of features is necessary or indispensable to each and every example.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain examples require at least one of X, at least one of Y and at least one of Z to each be present.

Similarly, while operations may be depicted in the drawings in a particular order, such operations, however, need not be performed in the particular order shown or in sequential order, or all illustrated operations to be performed, to achieve desirable results. Further, the drawings may schematically depict one or more example processes in the form of a flowchart. However, other operations that are not depicted can be incorporated in the example methods and processes that are schematically illustrated. For example, one or more additional operations can be performed before, after, simultaneously, or between any of the illustrated operations. Additionally, the operations may be rearranged or reordered in other implementations. In certain circumstances, multitasking and parallel processing may be advantageous. Moreover, the separation of various system components in the implementations described above should not be understood as requiring such separation in all implementations, and it should be understood that the described program components and systems can generally be integrated together into a single software product or packaged into multiple software products. Other implementations are within the scope of the following claims. In some cases, the actions recited in the claims can be performed in a different order and still achieve desirable results.

What is claimed is:

1. A system comprising:
at least one processor; and
a memory storing instructions that when executed by the at least one processor cause the system to:
receive image data associated with an environment;
process the image data to determine one or more images associated with the environment;
identify negative space in the one or more images;
label the negative space; and
recognize subjects in the one or more images by determining the negative space around or in-between the subjects.

2. The system of claim 1, wherein the image data comprises one or more of still images, photographs, animations, individual frames from a video, or a video.

3. The system of claim 1, wherein identify the negative space comprises: obtain pre-defined thresholds for identifying blank spaces in one or more images; and analyze the image data based on the pre-defined threshold to identify the negative space.

4. The system of claim 1, wherein the instructions that when executed by the at least one processor further cause the system to: tag the subjects in the one or more images; operate an autonomous driving system to based at least in part on the tagged subject.

5. One or more non-transitory computer-readable media comprising instructions that when executed by a computing system cause the computing system to:
receive image data associated with an environment;
determine light variations data associated with the environment;
analyzes light variations data to identify one or more shadows in the environment;
process the image data to identify one or more objects corresponding to the one or more shadows in the environment; and
analyze the one or more shadows to predict movements of the one or more objects.

6. The one or more non-transitory computer-readable media of claim 5, wherein the instructions, when executed by the computing system, cause the computing system to:
determine categories of light sources; and
classify and sort the light variations data based on the categories of light sources.

7. The one or more non-transitory computer-readable media of claim 5, wherein the instructions, when executed by the computing system, cause the computing system to:
define categories of energy strengths of light differences based at least in part in the image data; and
classify and sort variations in energy strengths of light differences in the image data

8. The one or more non-transitory computer-readable media of claim 5, wherein the instructions, when executed by the computing system, cause the computing system to:
obtain data associated with the one or more objects' attributes; and
classify light shapes and variations based at least in part on the one or more objects' attributes.

9. The one or more non-transitory computer-readable media of claim 8, wherein the one or more objects' attributes comprise one or more of: a form, a structure, and an object's ability to remain mobile.

10. The one or more non-transitory computer-readable media of claim 5, wherein the one or more shadows comprises stationary cast shadows and non-stationary cast shadows.

11. The one or more non-transitory computer-readable media of claim 5, wherein to identify one or more objects further cause the computing system to: determine negative space in the image data and identify the one or more objects based on the negative space in the image data.

12. A method comprising:
receiving image data associated with an environment;
determining light variations data associated with the environment;
analyzing light variations data to identify one or more shadows in the environment;
processing the image data to identify one or more objects corresponding to the one or more shadows in the environment; and
analyzing the one or more shadows to predict movements of the one or more objects.

13. The method of claim 12, further comprises:
determining categories of light sources; and
classifying and sorting the light variations data based on the categories of light sources.

14. The method of claim 12, further comprises:
defining categories of energy strengths of light differences based at least in part in the image data; and
classifying and sorting variations in energy strengths of light differences in the image data.

15. The method of claim 12, further comprises:
obtaining data associated with the one or more objects' attributes; and
classifying light shapes and variations based at least in part on the one or more objects' attributes.

16. The method of claim 14, wherein the one or more objects' attributes comprise one or more of: a form, a structure, and an object's ability to remain mobile.

17. The method of claim 12, wherein the one or more shadows comprises stationary cast shadows and non-stationary cast shadows.

18. The method of claim 12, where to identify one or more objects comprises: determining negative space in the image data and identifying the one or more objects based on the negative space in the image data.
